(19) United States
(12) Patent Application Publication
(10) Pub. No.: US 2017/0108163 A1
(43) Pub. Date: Apr. 20, 2017

(54) CABIN AIR COMPRESSOR OUTER BRACKET

(71) Applicant: HAMILTON SUNDSTRAND CORPORATION, Windsor Locks, CT (US)

(72) Inventors: Seth E. Rosen, Middletown, CT (US); Patrick McCord, Norwich, CT (US)

(21) Appl. No.: 14/886,226

(22) Filed: Oct. 19, 2015

(51) Int. Cl. F16M 13/02; B64D 13/06; F04D 29/60

(52) U.S. Cl. CPC F16M 13/02; F04D 29/60; B64D 13/06; B64D 2013/0603

(57) ABSTRACT

A support bracket includes a base including a first hole and a backplane perpendicular to the base. The support bracket also includes three or more connecting surfaces extending outwardly from a left side of the back plane and a mounting tab extending perpendicularly form an outer surface of the third connecting surface and having a mounting tab hole having a diameter formed therein. The support bracket has height and a ratio of the diameter of the mounting tab hole to the height of the bracket is between 0.0467 and 0.0469 in.

### BACKGROUND

The present disclosure relates to a cabin air compressor bracket for an aircraft environmental control system.

Environmental control systems (ECSs) are utilized on various types of aircraft for several purposes, such as in cooling systems for the aircraft. A cabin air conditioning and temperature control system (CACTCS) is an example of an aircraft ECS that includes air cycle packs supplied with pressurized outside (fresh) air from electric motor-driven cabin air compressors (CACs) which condition fresh air for cabin heating and cooling. The CACTCS provides flow control for modulation of cooling pack air flow, recirculation fans to circulate cabin air, and associated valves and sensors used for system control.

The CACTCS may also include a trim air system to provide individual cabin zone temperature control. This includes trim temperature control valves, trim duct heaters and associated sensors. As one example, a CACTCS may provide control of six baseline passenger zones and a flight deck zone. Additional zones, such as a forward cargo zone, a crew zone and/or an attendant zone may be controlled by other ECSs. Recirculation fans may also be provided for additional air flow to the passenger cabin and to ensure that flow at an air distribution nozzle remains constant.

### SUMMARY

These and other advantages and features will become more apparent from the following description taken in conjunction with the drawings.

In one embodiment, a support bracket includes a base including a first hole and a backplane perpendicular to the base. The support bracket also includes three or more connecting surfaces extending outwardly from a left side of the back plane and a mounting tab extending perpendicularly form an outer surface of the third connecting surface and having a mounting tab hole having a diameter formed therein. The support bracket has height and a ratio of the diameter of the mounting tab hole to the height of the bracket is between 0.0467 and 0.0469 in.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an upper support bracket assembled with a CACTCS;

FIG. 2 is a perspective view of the upper support bracket of FIG. 1;

FIG. 3 is a side-view of the upper support bracket of FIG. 1;

FIG. 4 is another side-view of the upper support bracket of FIG. 1; and

FIG. 5 is a cut-away side-view of the circled region in FIG. 5.

### DETAILED DESCRIPTION

As required for an understanding of this disclosure, detailed embodiments are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

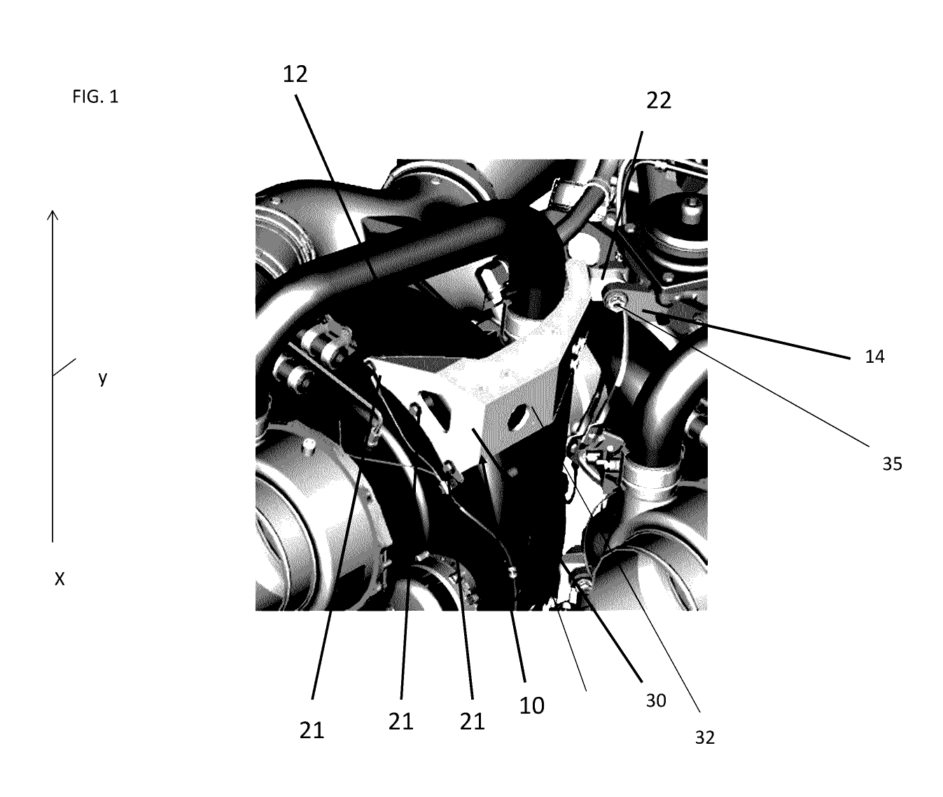

Referring to FIG. 1, an example of an upper support bracket 10 is shown. The support bracket 10 may be provided with an aircraft environmental control system such as a cabin air conditioning and temperature control system. The support bracket 10 is configured to interconnect a cabin air compressor 12 and a mount 14 coupled to a vibration isolator. A lower bracket (not shown) may also be included The upper and lower support brackets attach on upper and lower sides of the compressor 12 with above or upper being defined as being further from reference point x in the y direction.

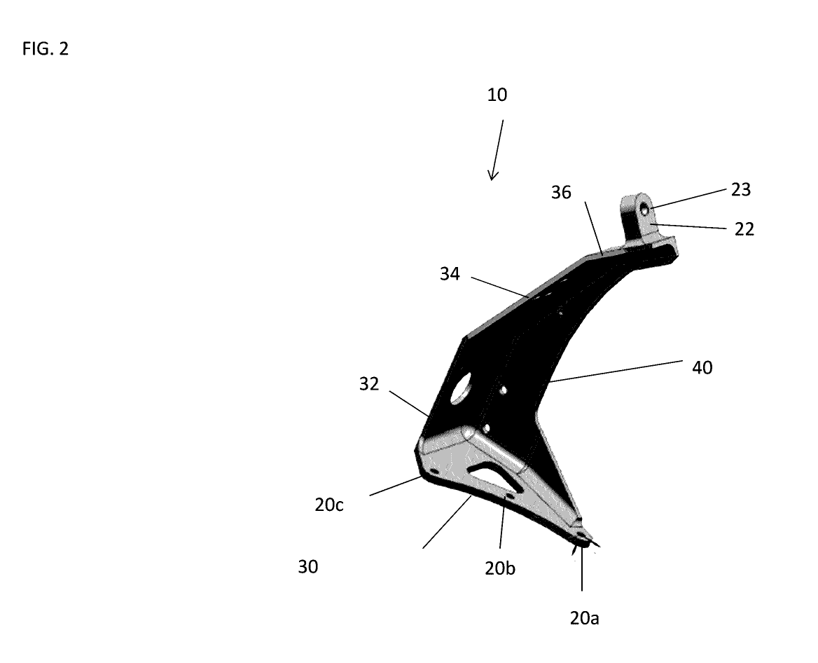

With reference now to FIGS. 1-5 the upper support bracket 10 includes a 3-way mounting surface that includes 3 attachment holes 20a, 20b, 20c through which fasteners 21 may be inserted to connect the compressor 12 to the support bracket 10. Herein, the surface containing the three holes 20a, 20b, 20c may be referred to as a compressor base interface or simply as base 30. One or more connecting surfaces 32, 34, 36 extend away from the base 30 to connect the base 30 to a mounting tab 22. The mounting tab 22 includes a hole 23 through which a fastener 35 may pass to couple the support bracket 10 to the mount 14.

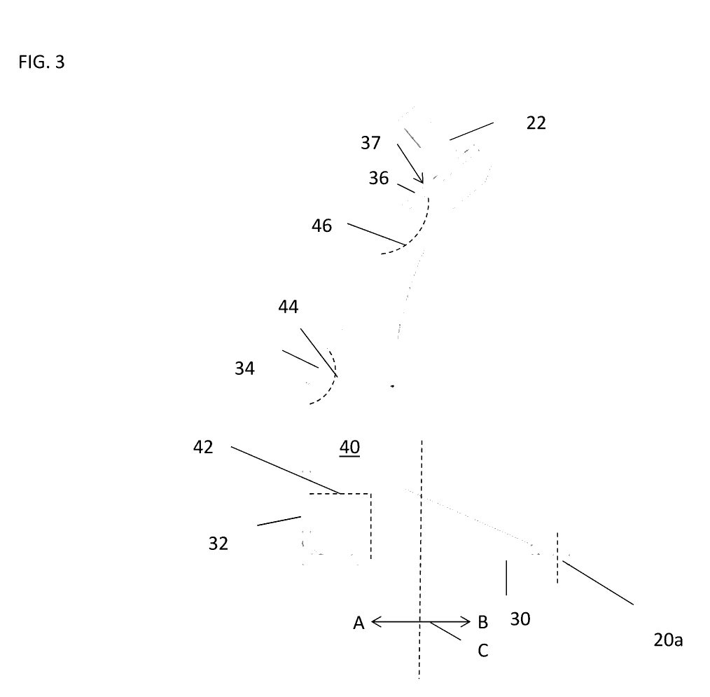

The upper support bracket 10 includes a backplane 40 connected to one or more of the connecting surfaces 32, 34, 36. The backplane 40 may define a reference plane in one embodiment. In such a case, the backplane has a left and right side and the one or more connecting surfaces 32, 34, 36 extend outwardly from a left side of the backplane 40. In FIG. 3, the left side is shown as being in direction A from reference line C and the right is shown as being in direction B from reference line C.

In one embodiment, first connecting surface 32 extends away perpendicularly away from the base 30 as indicated by right angle 42 between the two. The second connecting surface 34 forms an obtuse angle 44 relative to the first connecting surface 34. Similarly, the third connecting surface 36 forms an obtuse angle with the second connecting surface 34.

The mounting tab 22 extends perpendicularly away from an outer surface 37 of the third connecting surface 36.

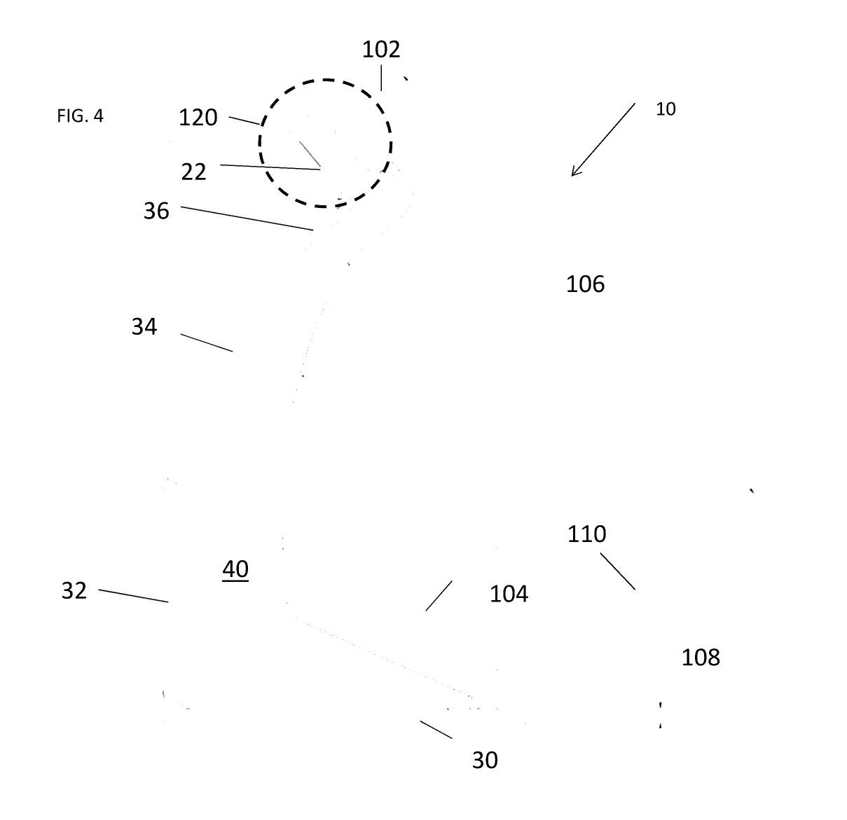

With reference now to FIG. 4, in one embodiment the first hole 22a includes a center line 104. Similarly, the hole 23 in the mounting tab 22 includes a centerline 102. In embodiment, the distance 106 between a line 110 parallel to the centerline 102 that passes through the first hole 22a and intersects the center line 104 and the centerline line 102 is about 13.608 in. In this context, the word about means + or −0.010 in. Herein, the distance 106 may be referred to as a height of the bracket 10.

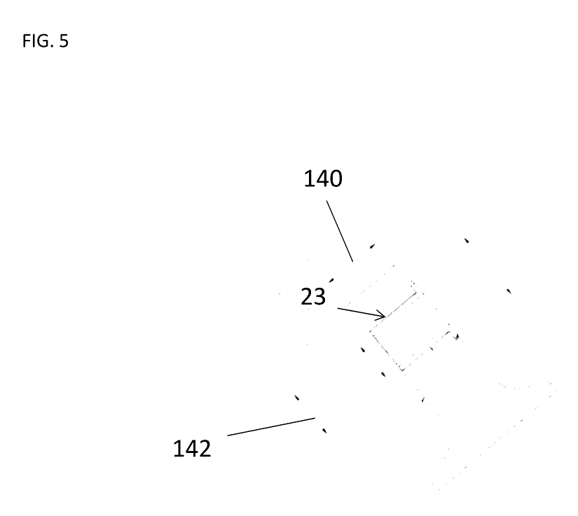

FIG. 5 shows an enlarged view of the area in circle 120 in cross section. As illustrated, the mounting tab 22 has a thickness 140 that is between about 0.815 in where about means + or −0.020 in. The hole 23 has an outer diameter 142 into which a bushing 144 may be inserted. The outer diameter 142 may be 0.6375 + or −0.0005 in in one embodiment and the bushing 144 may have an inner diameter 144 of 0.5 in in one embodiment.

In one embodiment, to provide the correct structural strength to support the cabin air compressor and maintain a weight that is not detrimental to flight, the thickness of the base 30 is 0.350in + or −0.020 in. In the same vein, in one embodiment, a ratio of the outer diameter 142 and the height 106 is between 0.0467 and 0.0469.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A support bracket comprising:
a base having a plurality of holes formed therein including a first hole;
a backplane perpendicular to the base;
connecting surfaces extending outwardly from a left side of the backplane, the connecting surfaces including a first connecting surface, a second connecting surface, and a third connecting surface, the first connecting surface extending upwardly from the base, the second connecting surface forming an obtuse angle with the first connecting surface, and the third connecting surface forming an obtuse angle with the second surface; and
a mounting tab extending perpendicularly from form an outer surface of the third connecting surface and having a mounting tab hole formed therein, the mounting tab hole having a diameter;
wherein the support bracket has a height defined as a distance between a line parallel to a centerline of the mounting tab hole and that passes through the first hole and intersects a centerline of the first hole and the centerline line of the mounting tab hole;
wherein a ratio of the diameter of the mounting tab hole to the height of the support bracket is between 0.0467 and 0.0469 in.

2. The support bracket of claim 1, wherein the mounting tab has a thickness is between 0.795 and 0.835 in.

3. The support bracket of claim 1, wherein the diameter of the mounting tab hole is between 0.637 and 0.638 in.

4. The support bracket of claim 3, further comprising:
a bushing disposed in the mounting tab hole.

5. The support bracket of claim 4, wherein an inner diameter of the bushing is about 0.5 in.

6. The support bracket of claim 1, wherein the base has a thickness between 0.330 and 0.370 in.
